(19) United States
(12) Patent Application Publication
(10) Pub. No.: US 2026/0350672 A1
(43) Pub. Date: Nov. 5, 2026

(54) Embedded Finance Rail for Loan, Lease, and Credit Offer Structuring in Platform Execution System

(71) Applicant: ADRIAN FARIAS JARAMILLO, JURUPA VALLEY, CA (US)

(72) Inventor: ADRIAN FARIAS JARAMILLO, JURUPA VALLEY, CA (US)

(21) Appl. No.: 19/336,090

(22) Filed: Sep. 22, 2025

Related U.S. Application Data
(63) Continuation of application No. 19/197,894, filed on May 2, 2025.
(60) Provisional application No. 63/786,937, filed on Apr. 10, 2025.
(60) Provisional application No. 63/787,944, filed on Apr. 13, 2025.
(60) Provisional application No. 63/788,834, filed on Apr. 15, 2025.
(60) Provisional application No. 63/791,534, filed on Apr. 20, 2025.
(60) Provisional application No. 63/792,918, filed on Apr. 23, 2025.

(51) Int. Cl. G06Q 30/0601; G06Q 10/083

(52) U.S. Cl. CPC G06Q 30/0611; G06Q 10/083

(57) ABSTRACT

An embedded finance system for sealed platform execution. Buyer fulfillment triggers are routed through an internal lending and lease logic engine. Offers are returned only from licensed entities. Fulfillment is locked to escrow, jurisdictional, and trust constraints. Unauthorized finance responses are denied.

### CROSS-REFERENCE TO RELATED APPLICATIONS

This application is a continuation of U.S. utility patent application Ser. No. 19/197,894, filed May 2, 2025, which claims the benefit of the following U.S. Provisional Patent Applications, each of which is incorporated herein by reference in its entirety:
U.S. Provisional Application No. 63/786,937, filed Apr. 10, 2025, titled “System and Method for Buyer-Initiated Marketplace Transactions Across Multiple Industries”
U.S. Provisional Application No. 63/787,944, filed Apr. 13, 2025, titled “Sealed Toolset and Logic Framework for Buyer-Initiated Offer Systems”
U.S. Provisional Application No. 63/788,834, filed Apr. 15, 2025, titled “Toolset Protection for Modular Buyer-Initiated Offer Ecosystem”
U.S. Provisional Application No. 63/791,534, filed Apr. 20, 2025, titled “Modular Toolset Architecture for Multi-Sector Buyer-Initiated Commerce Infrastructure”
U.S. Provisional Application No. 63/792,918, filed Apr. 23, 2025, titled “Lockdown: Final Enforcement Tools for Global Buyer-Initiated Transaction Control”

### FIELD OF THE INVENTION

The present invention relates generally to commercial transaction systems and, more specifically, to embedded finance logic used to structure loan, lease, and credit offers in response to buyer-initiated fulfillment triggers within a sealed execution platform.

### BACKGROUND OF THE INVENTION

Existing finance solutions for consumer and commercial transactions are disjointed, involving third-party lending systems, fragmented underwriting logic, and unsecured response mechanisms.

Traditional lending, leasing, and credit offer systems fail to integrate with trust-based, escrow-gated execution flows, exposing platforms to fraud, inefficiency, and fulfillment risk.

There is a need for a native, embedded finance module that receives buyer-initiated input and returns pre-underwritten offers that remain locked to licensed fulfillment rails.

### SUMMARY OF THE INVENTION

This invention introduces a finance rail embedded within a sealed platform execution system. It processes buyer-initiated fulfillment triggers and returns matched offers from lenders, lease providers, or credit pools—only if platform-bound underwriting and trust conditions are met.

Financial offers are returned as structured, verified responses with escrow-lock logic and jurisdictional control.

Unauthorized lenders or responses originating outside the platform are denied.

Offer execution only proceeds upon full metadata compliance, license clearance, and escrow enablement.

### DETAILED DESCRIPTION OF THE INVENTION

A finance rail module is embedded into the platform architecture, linked to buyer-facing tools.

When a buyer submits a fulfillment request, the platform routes it through the finance rail for offer structuring.

Offers are returned only if provider licensing, underwriting rules, and jurisdictional filters are passed.

Lenders and lessors must be registered and platform-licensed to respond.

Offers are structured with embedded escrow triggers, fulfillment limitations, and vendor trust linkage.

The finance rail allows for pre-approval logic, time-based offer expiration, and dynamic limit setting.

Buyer metadata, credit scope, jurisdiction, and transaction size are used to tune underwriting.

Offers are logged with metadata, scoring, and audit references.

Unauthorized entities or attempts to bypass platform rails are blocked and logged.

Finance offers may include purchase loans, equipment leases, buy-now-pay-later models, or revolving lines —all gated through platform execution logic. What is claimed is:

1. A system comprising:
a buyer-facing execution rail;
an embedded finance module;
and a fulfillment controller that matches credit, loan, or lease offers upon platform-verified input.

2. The system of claim 1, wherein the embedded finance module filters responses based on jurisdiction, creditworthiness, and platform trust tier.

3. The system of claim 1, wherein lenders must be licensed within the platform to deliver structured offers.

4. A method comprising:
receiving a buyer fulfillment trigger;
routing it through a finance module;
returning verified offers;
and locking fulfillment to a sealed execution path.

5. The system of claim 1, wherein finance offers include pre-approval, escrow-lock terms, and time-based expiration.

6. The method of claim 4, wherein unlicensed finance offers are denied and flagged.

7. The system of claim 1, further comprising escrow logic linked to the execution of finance-backed offers.

8. A method for embedding lease offers into a buyer-execution rail, comprising: receiving a tool-triggered input; validating metadata; and returning offers only from platform-cleared sources.

9. The system of claim 1, wherein metadata includes buyer profile, credit signals, jurisdiction, and tool session ID.

10. The method of claim 4, wherein offer execution is blocked unless escrow, jurisdiction, and vendor permissions are satisfied.

11. A finance enforcement controller that prevents third-party lending platforms from fulfilling buyer triggers outside the sealed rail system.

12. The system of claim 1, wherein credit card or revolving credit offers must be escrow-cleared before vendor activation.

13. A platform-locked loan delivery method comprising:
filtering based on buyer data;
matching to internal credit pools;
and triggering offer display upon license match.

14. The system of claim 1, wherein offer responses include embedded metadata signatures for audit compliance.

15. A method of structuring credit responses to buyer tool input comprising:
dynamic scoring, escrow enforcement, and platform-only response eligibility.

16. The system of claim 1, wherein attempted offer injection by external lenders is rejected and reported.

17. A platform-native lease structuring system with jurisdictional lock and escrow-stage funding control.

18. The method of claim 4, wherein finance options are filtered based on transaction type and trust parameters.

19. A sealed rail finance fulfillment engine that embeds loan logic, vendor filters, and metadata scoring.

20. The system of claim 1, wherein finance responses are tethered to fulfillment timing, location, and tool origin constraints.
